(19) United States
(12) Patent Application Publication
(10) Pub. No.: US 2018/0244214 A1
(43) Pub. Date: Aug. 30, 2018

(54) DEVICE COMPRISING A FLOOR COVER FOR A LOADING SPACE

(71) Applicant: Brose Fahrzeugteile GmbH & Co. Kommanditgesellschaft, Coburg, Coburg (DE)

(72) Inventor: Udo GETTA, Berlin (DE)

(21) Appl. No.: 15/754,256

(22) PCT Filed: Aug. 25, 2016
(86) PCT No.: PCT/EP2016/070062

§ 371 Date: Apr. 12, 2018

(30) Foreign Application Priority Data
Sep. 4, 2015 (DE) 10 2015 217 006.3

(51) Int. Cl. B60R 13/01; B60R 5/04

(52) U.S. Cl. CPC B60R 13/013; B60R 5/04

(57) ABSTRACT

It is provided a device for securing at least one object that is arranged on a loading area of a loading space of a vehicle, comprising a preferably flat securing element that is adjustable in a power-operated way between a position of non-use and a position of use and in the position of use can take a loading position and a securing position, wherein in the loading position at least one object can be arranged on the loading area and in the securing position the at least one object is held in a position on the loading area via the securing element. A floor cover is provided, which partly or completely protectively covers the securing element in its position of non-use and in the position of non-use of the securing element defines a portion of a loading floor on which at least one object can be arranged.

### CROSS-REFERENCE TO A RELATED APPLICATION

This application is a National Phase patent application of International Patent Application Number PCT/EP2016/070062, filed on Aug. 25, 2016, which claims priority of German Patent Application Number 10 2015 217 006.3, filed on Sep. 4, 2015, the contents all of which are included herein by reference.

### BACKGROUND

This invention relates to a device for load securement and to a device. There are known devices which are equipped and provided to secure at least one object that is arranged on a loading area of a loading space of a vehicle. For example, such a device is provided for securing loaded goods on a rear-side loading area of a motor vehicle. Such a device therefor includes a preferably flat securing element, for example in the form of a securing mat or a securing net, by means of which the object arranged on the loading area or a plurality of objects is/are held in a position on the loading area and hence is/are secured against an unwanted displacement for example on braking of the vehicle.

For example, a generic device for load securement is known from the DE 197 22 501 A1. This device includes a flat securing element designed in the form of a flexible securing net, by means of which objects arranged on a rear-side loading area can be secured. By means of a Bowden cable system, the securing net can be transferred from a loading position, in which the securing net extends substantially along the vertical, into a securing position in which the securing net extends over objects arranged on the loading area and tightly spans the same. With a free end, the securing net to be unwound from a winding roller is guided along two connecting link guides extending above the loading area, by means of which during an adjustment from the loading position into the securing position the free end of the securing net is guided along a roof-side longitudinal beam and on along the opposed C-pillars of the vehicle downwards to the rear region of the loading area.

To be able to compactly stow the securing net of DE 197 22 501 A1 when not in use, it is conceivable to store the same completely wound up on the winding roller. From a thereby defined position of non-use of the securing net, the securing net can be transferred into the partly stretched loading position. In this loading position the securing net extends substantially along the vertical, before load to be secured via the securing net is positioned on the rear-side loading area of the vehicle. Stowing of the securing net and unwinding from the winding roller in order to be able to again adjust the securing net between the loading position and the securing position in a power-operated way is possible, however, only manually. In addition, due to the chosen construction of the device with its winding roller, a securement of the load only can be achieved via the connecting link guides to be integrated into the vehicle interior lining with great expenditure.

Furthermore, covers for loading spaces in vehicles are known which close a receptacle for a spare tire or a jack and in their closed position define a part of the loading area. Such cover usually is formed by an individual thin-walled plate that must be lifted off manually and be removed from the loading space in order to gain access to the spare tire or the jack. From practice, covers furthermore are known already in which an underlying receptacle for loaded goods is used and a floor of the receptacle defines a loading area for an increased loading space. Such receptacles and covers, however, so far have not been suitable for accommodating a securing element. In addition, such covers regularly are bulky and can only be removed or adjusted manually by a user.

### SUMMARY

It therefore is an object of the invention to improve a device for load securement in this respect and in particular increase the operating comfort for a device to be provided in a loading space, which includes a securing element and/or a receptacle with a cover.

This object is achieved by devices as described herein. According to a first aspect of the invention a device for load securement and according to a second aspect of the invention a device with a floor cover for partly or completely closing a receptacle are proposed. The features of the devices according to the two aspects of the invention can also be combined with each other, as will yet be explained below.

A first device for load securement according to the invention not only includes a preferably flat securing element that is adjustable between a position of non-use and a position of use in a power-operated way, i.e. for example by means of an electromotive, pneumatic and/or hydraulic drive. Rather, the device also provides a floor cover that partly or completely protectively covers the securing element in its position of non-use and in the position of non-use of the securing element defines a portion of a loading floor on which at least one object can be arranged.

In the solution according to the invention, a loading floor thus is defined above the loading area via the floor cover for the securing element present in its position of non-use, on which load can be secured via the securing element in its position of use. The loading floor of the floor cover hence creates an additional possibility for loading objects, such as items of luggage, when the securing element is not used, without the risk of a damage of the unused securing element. The securing element in this case rather is accommodated in a protected way below the floor cover. The floor cover therefor for example at least partly covers a receptacle for the securing element present in its position of non-use. The securing element can be transferred into a position of non-use via a corresponding drive unit of the device and be retracted into the receptacle. Via the floor cover it then is achieved that the loading space of the vehicle can fully be utilized by the securing element present in its position of non-use. When the securing element, which preferably is of the flat and flexible type in order to effectively secure loaded goods arranged on the loading area in the securing position, is to be transferred from its position of non-use into a position of use, the floor cover is removed or opened manually or likewise in a power-operated way.

In one design variant it is provided that at least one element of the floor cover is pivotally mounted and/or can be wound in order to adjust the floor cover. At least one element of the floor cover thus is pivoted and/or wound up in order to adjust the floor cover from a closed position, in which the securing element present in its position of non-use is covered by the floor cover, into an open position. This design variant in particular includes the provision of an individual pivotable covering element in the form of a covering flap that is pivotally mounted on a component firmly installed in the loading space and can be folded to the side or forwards (in the direction of the vehicle front and hence e.g. in the direction of a rear seat of a vehicle) in order to permit a power-operated adjustment of the securing element from its position of non-use into a position of use. The aforementioned design variant furthermore also includes a solution in which a plurality of (at least two) pivotable covering elements of the floor cover, which each cover the securing element in its position of non-use, define a portion of the loading floor.

In one design variant a pivotable element of the floor cover, in particular a pivotable covering element which in the position of non-use of the securing element defines a part of the loading floor, in the properly mounted condition of the device in the vehicle is pivotable to the right or left or in the direction of a vehicle front with respect to a longitudinal vehicle axis in order to provide for an adjustment of the securing element from its position of non-use into its position of use. Folding up sideways or folding away forwards, away from a rear-side loading edge, for example is provided to be able to extend a securing element upwards and utilize a loading area then located thereunder for the arrangement of objects. When the securing element then is again adjusted downwards in the direction of the loading area and the loaded goods are spanned tightly, the loaded goods are sufficiently secured against unwanted slippage on the loading area via the securing element.

In one exemplary embodiment the floor cover comprises at least two covering elements articulated to each other, which each cover the securing element in its position of non-use and define a portion of the loading floor. The use of covering elements articulated to each other in particular includes large-surface covering elements articulated to each other, which in small numbers already partly or completely cover the loading area and/or the securing element present in its position of non-use.

A floor cover with at least two covering elements articulated to each other, however, also includes a configuration in which the floor cover is formed of a plurality of narrow covering elements articulated to each other in the manner of roller blind slats. Such a plurality of relatively narrow covering elements articulated to each other then can also be wound up easily. In the unwound condition, however, a sufficient stability for the formation of a loading floor defined above the loading area furthermore can be provided via inherently rigid covering elements.

With at least two preferably plate- or flap-shaped covering elements articulated to each other the same can be foldable onto each other in order to provide for an adjustment of the securing element from its position of non-use into its position of use. A covering element here for example is pivotally mounted on a component firmly installed in the loading space and can be folded away to the side in order to provide for an extension of the securing element. A further covering element is pivotally mounted on this covering element to be folded up sideways and thus can be folded onto the same in order to clear an adjustment path for the securing element and be able to transfer the same into its position of use.

In one exemplary embodiment at least two pairs with two covering elements each articulated to each other are provided. Each pair of covering elements can comprise a first covering element that is pivotally mounted on a component firmly installed in the loading space, wherein the two first covering elements are pivotable in opposite directions in order to provide for an adjustment of the securing element from its position of non-use into its position of use. For example, a four-part loading floor thus is provided via the floor cover, below which the securing element is protectively accommodated in its position of non-use. When the securing element is to be adjusted in its position of use in a power-operated way, two parts of the floor cover in the form of two plate-shaped covering elements or covering plates each are folded to the right and left.

In principle, however, it is also possible that only one first covering element is pivotally mounted on a component firmly installed in the loading space and a further, second covering element is pivotally mounted on this first covering element. In such a case, only a two-part loading floor hence is provided by the floor cover for the securing element. In alternative design variants a multipart loading floor of the floor cover of course can also comprise more than two, three or four parts, i.e. more than one, two or three covering elements.

At least one covering element of the floor cover with one portion can be shiftably guided on a component firmly installed in the loading space in order to thereby specify a defined adjustment path for opening and closing the floor cover by the covering element. The guidance for example can be given via a connecting link guide in which a guide element on the covering element, for example in the form of a sliding block, is shiftably held in a connecting link guide on the component firmly installed in the loading space.

As already briefly explained above, it can alternatively or additionally be provided in one design variant that the securing element in its position of non-use is accommodated in a receptacle which in the position of non-use of the securing element is completely covered by the floor cover. In one exemplary embodiment, this receptacle defines an essential part of the loading area on which objects to be secured by the securing element can be arranged when the securing element is present in its position of use and in particular in its loading position. At an edge of this receptacle the above-mentioned guidance of a portion of a shiftable and/or pivotable covering element then can be provided.

In one exemplary embodiment, a component firmly installed in the loading space and in particular the receptacle for the securing element is formed by a component of the device itself. For example, the device is configured as a premounted module with a loading floor insert on which a covering element or a plurality of covering elements already is/are adjustably mounted as intended, just like a motorized drive unit provided therefor and the power-operated adjustable securing element. This loading floor insert then can be mountable in a rear-side loading space of a motor vehicle in order to comparatively easily equip the vehicle with a securing element extendable from the receptacle of the loading floor insert, which in its position of non-use is covered by a floor cover that itself defines a loading floor for loaded goods.

The floor cover can be adjustable in a power-operated way between a closed position and an open position, wherein in the open position an adjustment of the securing element from its position of non-use into the position of use is made possible. In this connection it can be provided that the floor cover is adjustable in a power-operated way both into its open position and into its closed position or is adjustable into only one of said positions, while an adjustment into the other position can be carried out manually.

The variant to provide a floor cover that is adjustable in a power-operated way in a vehicle loading space apparently also is advantageous without the provision of a securing element. Via a power-operated floor cover a preferably large-surface or large-volume receptacle in the loading space can be closed and be adjusted at the request of a user by means of an electromotive, pneumatic and/or hydraulic drive unit. For example, a kind of storage box thereby is provided in a loading space of a vehicle, which is completely closed by a power-operated floor cover that in the closed condition defines a loading floor and that can be opened and closed comfortably.

Correspondingly, according to a further aspect of the invention a device for a loading space of a vehicle is proposed, in which a floor cover is provided which in a closed condition partly or completely covers the loading area and which at least partly closes the receptacle including the loading area, so that the floor cover defines a portion of a loading floor above the loading area, on which at least one object can be arranged. The floor cover here is adjustable in a power-operated way into an open condition in order to partly or completely gain access to the loading area, i.e. to clear the receptacle when necessary, without having to manually engage the floor cover. The receptacle for example can have the form of a trough within the loading space, in particular on a loading floor insert.

The floor cover for covering the receptacle can be configured analogous to the aforementioned exemplary embodiments, without a securing element that is extendable from the receptacle having to be provided. The receptacle rather can serve as a storage space for other objects or be usable for increasing the loading space when the floor cover is open.

A drive unit for the power-operated adjustment of the floor cover and in particular of possible covering elements of the floor cover can include at least one electric motor, a pneumatic cylinder, a hydraulic cylinder, an electric pull magnet and/or a shape memory alloy. For torque and speed adaptation for example a preferably single-stage spur-gear transmission, a worm gear and/or a toothed belt can be provided.

In one exemplary embodiment, a drive unit for the power-operated adjustment of the floor cover includes at least one flexible traction means, for example in the form of a Bowden cable or belt, in order to transmit a pulling force for opening and/or closing the floor cover. Alternatively, at least one spindle drive can be provided in order to transmit an adjusting force for opening and/or closing the floor cover.

Independent of the chosen transmission means for the transmission of an adjusting force or pulling force to an element of the floor cover in order to open and/or close the same, it can be provided in principle that a drive unit comprises at least one shiftably mounted traveling part to be driven for a movement along a specified path of adjustment, which cooperates with the floor cover in order to open and/or close the floor cover. Such traveling part for example can be a carriage that is formed by a spindle nut drivable along a spindle axis or comprises such spindle nut. Alternatively, such traveling part can include a gear wheel that meshes with a rack in order to transmit an adjusting force. In a further alternative design variant the traveling part can be a shiftably mounted carrier element that is connected to a flexible traction means, for example in the form of a Bowden cable or a belt, and thereby can be driven to perform an adjusting movement.

The drive unit in principle can be coupled to an electronic control unit for automatically opening and/or closing the floor cover. Via such an electronic control unit for example at least one electromotive, pneumatic or hydraulic drive of the drive unit is controlled in order to trigger an adjustment of the floor cover in a power-operated way in response to an operating event. Such operating event for example can be the manual actuation of a control element, for example in the form of a key on the vehicle, in particular in its loading space. An operating event can, however, also be generated by actuating a control element of a remote control unit. Alternatively or in addition, an automatic adjustment of the floor cover and of the securing element can be controllable via the electronic control unit, for example in response to a signal from the on-board electronic system of the vehicle.

To ensure the functioning of the drive unit an overcurrent detection can be provided, for example. Alternatively or in addition, there can be provided at least one sensor for detecting a desired end position of the floor cover and/or of at least one adjustable element of the floor cover and/or of the securing element.

In one exemplary embodiment a drive unit for the power-operated adjustment of the floor cover—possibly in addition to an electromotive, pneumatic and/or hydraulic drive—includes at least one spring element via which a restoring force for closing the floor cover is applied. Such spring element thereby triggers an automatic closing movement of the floor cover or at least supports this closing movement. In one variant, a restoring force for opening the floor cover can be applied via at least one spring element. The use of at least one spring element moreover also is advantageous in a floor cover that in principle comprises only manually adjustable covering elements. Via the at least one spring element at least one of the possible adjusting movements—for opening or for closing the floor cover—can at least be supported.

A drive unit for the power-operated adjustment of the floor cover can of course also comprise a plurality of electromotive, pneumatic and/or hydraulic drive units which adjust two or more adjustably mounted covering elements of the floor cover. When using two drive units, the adjustments of the two or more covering elements can also be effected mechanically and/or electrically independent of each other, so that individual areas of the floor cover can be opened and/or closed separately from other areas of the floor cover as required.

Independent of the chosen drive concept for adjusting the floor cover, it can be advantageous for stiffening especially large-surface covering elements of the floor cover, when on an underside of the floor cover facing the loading area and the covered securing element, preferably on an underside of the covering element of the floor cover, a plurality of support elements are provided. These support elements can serve the stiffening and/or the improved support of the floor cover in its closed position. For example, these support elements are configured in the form of local protrusions, in particular as support domes. These support domes on an underside of the floor cover then for example are fixed to the underside or formed thereon spatially at a distance from each other.

### BRIEF DESCRIPTION OF THE DRAWINGS

Further advantages and features of the invention will become apparent from the following description of exemplary embodiments with reference to the Figures.

FIGS. 1A to 1D show a design variant of a device for load securement according to the invention comprising a floor cover defining a multipart loading floor and an extendable securing element in different positions.

FIG. 2 shows a perspective view of a further design variant of an inventive device for load securement and/or for the provision of an additional receiving space below a multipart loading floor of a floor cover adjustable in a power-operated way.

FIGS. 3A to 3C show the device of FIG. 2 in different positions of the floor cover.

FIG. 4 shows the device of FIGS. 2 and 3A to 3C with the floor cover opened.

FIGS. 5A and 5B show details of a drive unit of the device of FIGS. 2, 3A to 3C and 4 on an enlarged scale.

### DETAILED DESCRIPTION

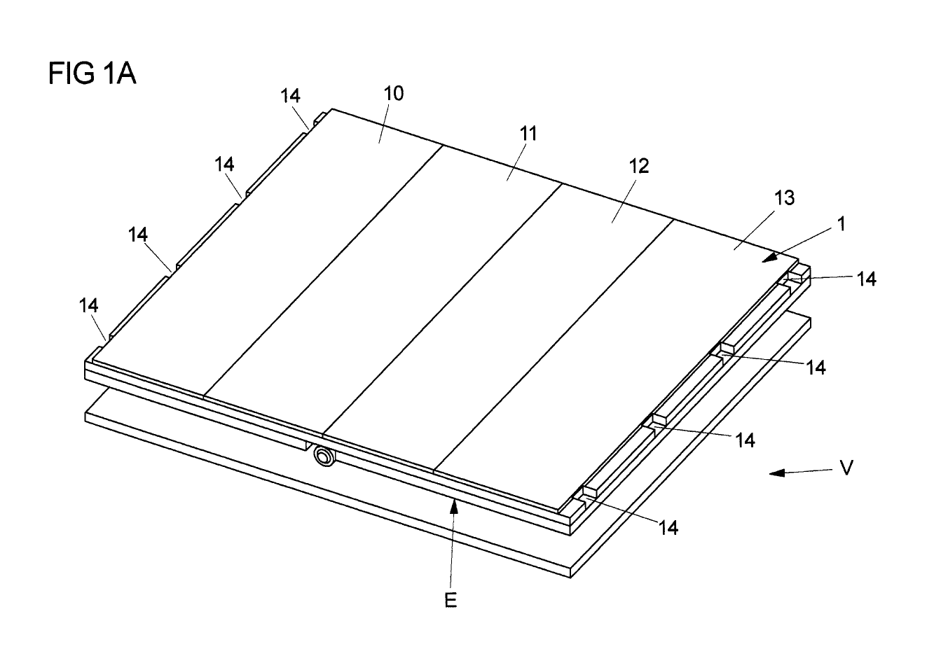

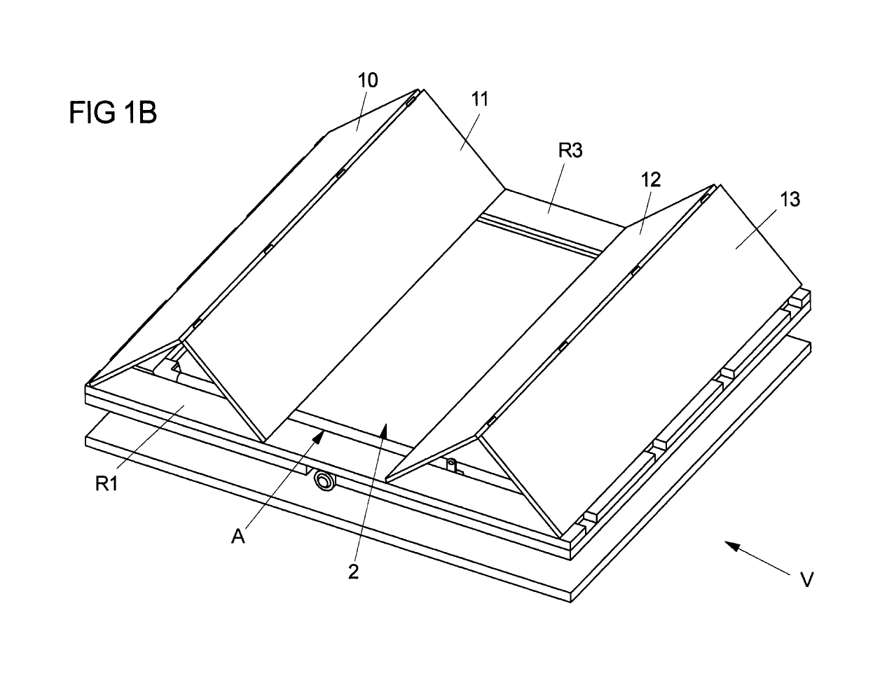

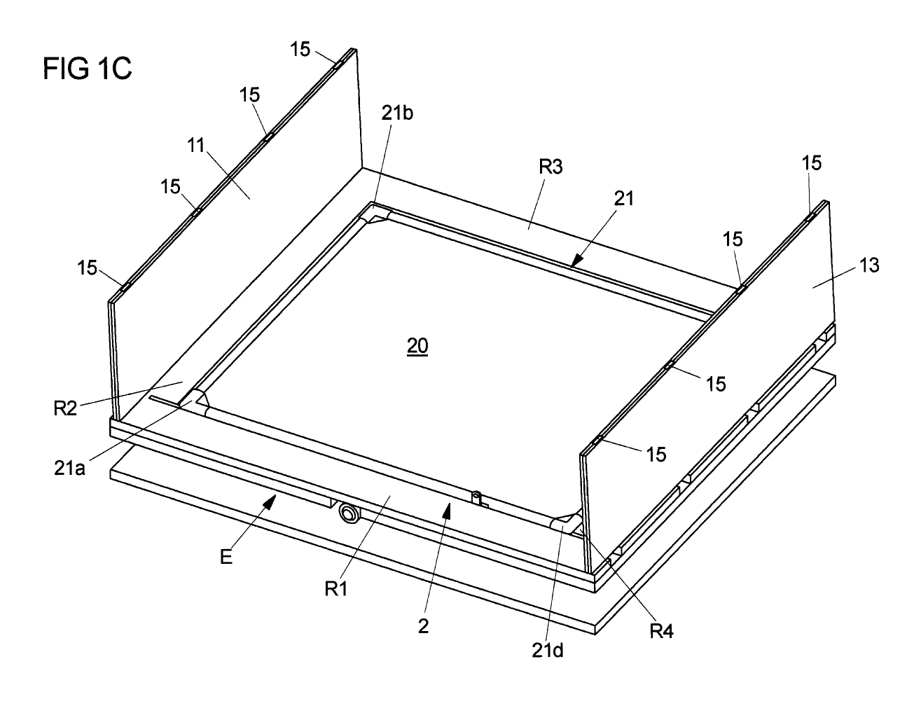

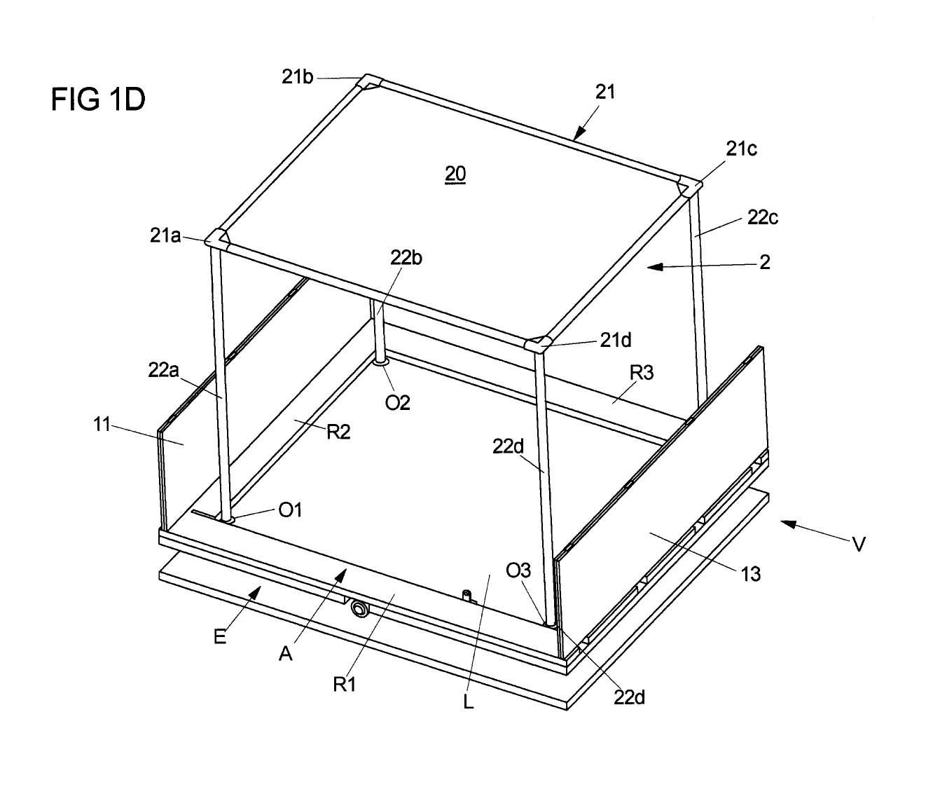

FIGS. 1A to 1D show a device V for load securement designed according to the invention for a rear-side loading space of a motor vehicle. The device V in particular includes a securing element in the form of a securing mat 2 that is adjustable in a power-operated way between a position of non-use and a position of use. In its position of non-use, this securing mat 2 is accommodated in a receptacle A on a loading area L in a stretched and hence flat condition. From this receptacle A, the securing mat 2 is extendable substantially along the vertical into an extended position of use.

In the position of use, the securing mat 2 in particular can take a loading position, as it is shown in FIG. 1D, so that below the securing mat 2 moved upwards loaded goods can be arranged on the loading area L. Since the securing mat 2 includes a flexible textile part 20 that on lowering of the securing mat 2 into a securing position can be stretched tightly over the objects arranged on the loading area L, these objects forming the loaded goods are secured against slippage on the loading area L via the securing mat 2.

To extend the securing mat 2 into its position of use and to adjust the same between a loading position and a securing position, in which the securing mat 2 is stretched tightly over objects arranged on the loading area L in order to hold the same in a defined position on the loading area L, a motorized adjusting device is provided, which is not shown here in all its details. This adjusting device in particular includes a plurality of adjusting elements in the form of link chains 22a to 22d. In the present case, four self-stiffening link chains 22a, 22b, 22c and 22d are provided, which each engage an end piece 21a to 21d of a support frame 21 of the securing mat 2. Between this support frame 21 the flat textile part 20 is stretched. By extending the self-stiffening link chains 22a to 22d from four associated (corner) openings in the—here rectangular—loading area L, of which merely 3 openings O1 to O3 are shown in the attached FIGS. 1A to 1D, the support frame 21 can be lifted and lowered and the possibly multilayer textile part 20 thereby can be stretched tightly over loaded goods arranged on the loading area L, when it is adjusted from the loading position into its securing position.

The link chains 22a to 22d for example are deflected below the respectively associated opening in order to be accommodated in the most space-saving way. The link chain 22a to 22d elastic per se to this end stiffens on extension from the respectively associated opening via chain links positively engaging into each other, as is described for example in the German Patent Application DE 10 2014 218 256.5.

To protectively cover the securing mat 2, if necessary, in its position of non-use, in which it is stretched and hence accommodated in the receptacle A so as to extend over a large part of the loading area L, and to avoid that objects must be placed directly on the securing mat 2, the device V here is equipped with a floor cover 1. This floor cover 1 in the present case completely covers the securing mat 2 accommodated in the receptacle A, when the same is present in its position of non-use. In addition, the floor cover 1 in the present case is formed such that it can be opened and closed in a power-operated way via a drive unit comprising at least one electromotive, pneumatic and/or hydraulic drive motor.

In the present case, the floor cover 1 is equipped with a plurality of pivotally mounted covering elements in the form of covering plates 10, 11, 12 and 13. These covering plates 10 to 13 define a multipart loading floor which in the closed position of the floor cover 1 extends above the loading area L and above the securing mat 2 and provides for depositing objects in the loading space without damaging the retracted securing mat 2. The individual covering plates 10 to 13 are comparatively stiff and possibly provided with one or more support domes on their underside facing the securing mat 2 present in its position of non-use and the loading area L for an additional stiffening and/or additional support.

Two covering plates 10, 11 and 12, 13 each are articulated to each other via a plurality of rotary plate joints in the form of plate hinges 15. One pair of covering plates 10, 11 and 12, 13 each can thereby be folded together in the manner of a folding shutter. The covering plates 10, 11 or 12, 13 articulated to each other thus can be folded onto each other. In addition, one first (left or right) outer covering plate 10 or 13 each is articulated to a component firmly installed in the loading space via a plurality of rotary joints in the form of hinges 14 and thus pivotally mounted thereon. In this way, the total of four covering plates 10 to 13 of the floor cover 1 can be folded up if necessary in order to provide for an extension of the underlying securing mat 2 and gain access to the loading area L.

When folding up the floor cover 1, two covering plates 10 and 11 or 12 and 13 each are swiveled open to the left or right, i.e. in the mounted condition in the direction of a left or right wheelhouse, and folded onto each other. In the condition folded up, the two pairs of covering plates 10, 11 and 12, 13 face each other along a vehicle transverse axis and extend substantially along the vertical, i.e. in the present case each are rotated by about 90° with respect to their respective position in the closed condition of the floor cover 1.

For the defined and preferably power-operated adjustment of the covering plates 10 to 13 of the floor cover 1, the respectively inner covering plates 11 and 12 are shiftably held on a component firmly installed in the loading space, preferably on a component of the device V firmly installed in the loading space. Preferably, in the region of a longitudinal edge of a covering plate 11 or 12 each facing the opposed covering plate 12 or 11, a traveling part, possibly equipped with an additional coupling element for the connection to the respective covering flap 11 or 12, is shiftably mounted. Such traveling part is translatorily shiftable transversely to the axes of rotation defined by the hinges 14 and 15, for example via a spindle drive or a Bowden cable drive, and hence is configured and equipped to transmit an adjusting force to the respective inner covering plate 11 or 12 of a pair of foldable covering plates 10, 11 or 12, 13. An adjusting force that acts in the direction of the axis of rotation of the respectively associated outer (second) covering plate 10 or 13 leads to an erection of the two covering plates 10, 11 and 12, 13 articulated to each other and to these covering plates 10, 11 and 12, 13 folding onto each other in pairs, until the covering flaps 10, 11 and 12, 13 at least partly are put up in pairs to such an extent that the securing mat 2 can be extended.

For torque and speed adaptation, a preferably single-stage spur-gear transmission, a worm gear and/or a toothed belt can be provided in the associated drive unit for the power-operated adjustment of the floor cover 1. Alternatively or in addition, at least one spring element can be provided to support an adjusting movement for opening or closing the floor cover.

In the illustrated exemplary embodiment of FIGS. 1A to 1D a component of the device V firmly installed in the loading space is formed by a loading floor insert E. This loading floor insert E forms the receptacle A. Furthermore, not only the non-illustrated drive unit can be mounted on the same below the loading area L, but also slotted guides for specifiying a defined path of adjustment transversely to the axes of rotation defined by the hinges 14 and 14 for folding the covering flaps 10 to 13 open and closed as well as parts of an adjusting device comprising the link chains 22a to 22d.

The loading floor insert E in the present case includes four edge portions R1 to R4 bordering the receptacle A and protruding raised with respect to the receptacle A. On the front and rear edge portions R1 and R3 each extending transversely, the respective inner covering flaps 11 and 12 are shiftably guided. On the two lateral, outer edge portions R2 and R4 the one outer covering flap 10 or 13 each is pivotally mounted.

The device V can be of modular construction with the loading floor insert E, so that a prefabricated modular unit is formed by means of the loading floor insert E on which the covering plates 10 to 13 already are pivotally mounted, the securing mat 2 is accommodated in the receptacle A, and the adjusting device with the link chains 22a to 22d for the securing mat 2 and the drive unit for the power-operated adjustment of the covering plates 10 to 13 are operable and pre-testably mounted.

Instead of laterally folding away two pairs of covering plates 10, 11 and 12, 13 in order to open a floor cover 1, it can also be provided to swivel open or fold up an individual covering plate or a plurality of covering plates articulated to each other merely towards one side. This includes in particular a process of swiveling open or folding up, in which the respective covering plate in the open position of the floor cover 1 then is arranged vertically to the rear seat bench or to a right or left wheelhouse of the vehicle. In the case of more than two covering plates, which can be folded onto each other for opening the floor cover, the same can be foldable onto each other in the manner of an accordion.

In another design variant the covering elements for covering the securing mat 2 in their position of non-use are configured in significantly larger numbers and narrower, in the manner of slats. For opening the floor cover towards the side or towards the vehicle front (in the direction of a rear seat), the slats then articulated to each other can be wound up in order to open the floor cover 1.

By means of an electronic control unit, an adjusting movement for opening and/or closing the floor cover 1 moreover can be controlled, for example after occurrence of a manually triggered operating event and/or in response to a signal from the on-board electronic system of the vehicle.

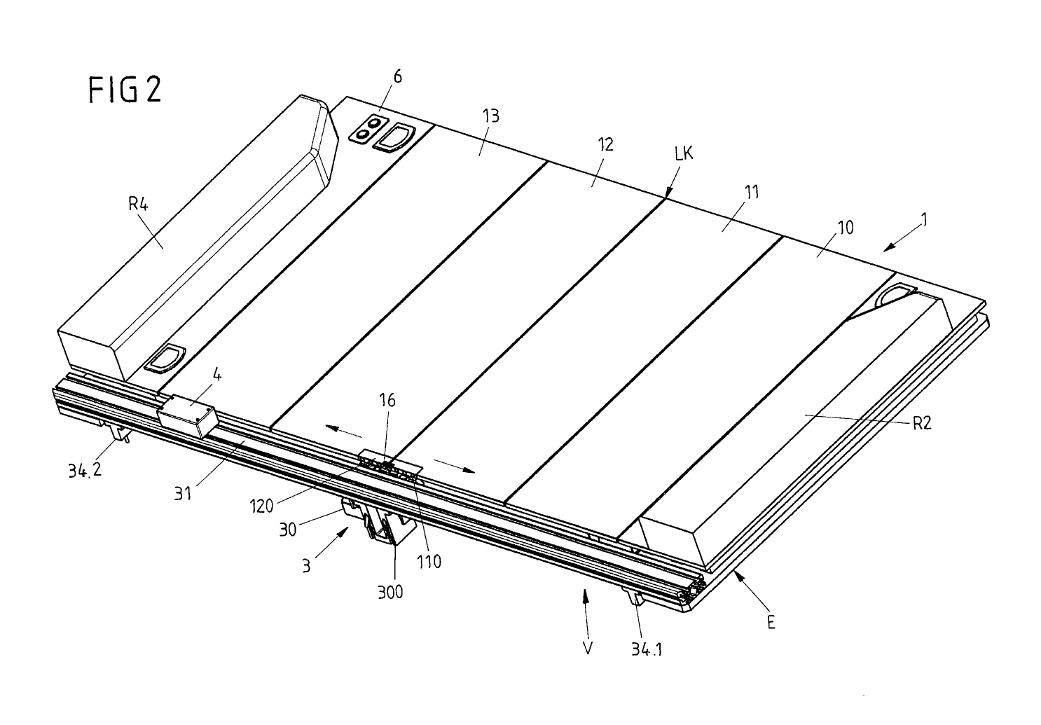

FIGS. 2, 3A to 3C, 4 and 5A to 5B illustrate a variant of a device V according to the invention, which in combination with a securing element 2 can be combined corresponding to the design variant of FIGS. 1A to 1D, but which also can easily be utilized without such a securing element 2. In the variant of FIGS. 2, 3A to 3C, 4 and 5A to 5B components corresponding with the variant of FIGS. 1A to 1D are designated with identical reference numerals. Moreover, the variant of FIGS. 2, 3A to 3C, 4 and 5A to 5B shows details of a drive unit 3 that likewise can be used in a device V according to FIGS. 1A to 1D.

The device V of FIGS. 2 to 5B in correspondence with the design variant of FIGS. 1A to 1D explained above includes a floor cover 1 that is formed by a plurality of covering plates 10 to 13 of which covering plates 10, 11 and 12, 13 are articulated to each other. The respective outer covering plate 10 or 13 of a pair of covering plates 10, 11 or 12, 13 each is articulated to an edge portion R2 or R4, so that the covering plates 10 to 13 can be folded together and folded up in pairs in order to open the floor cover 1.

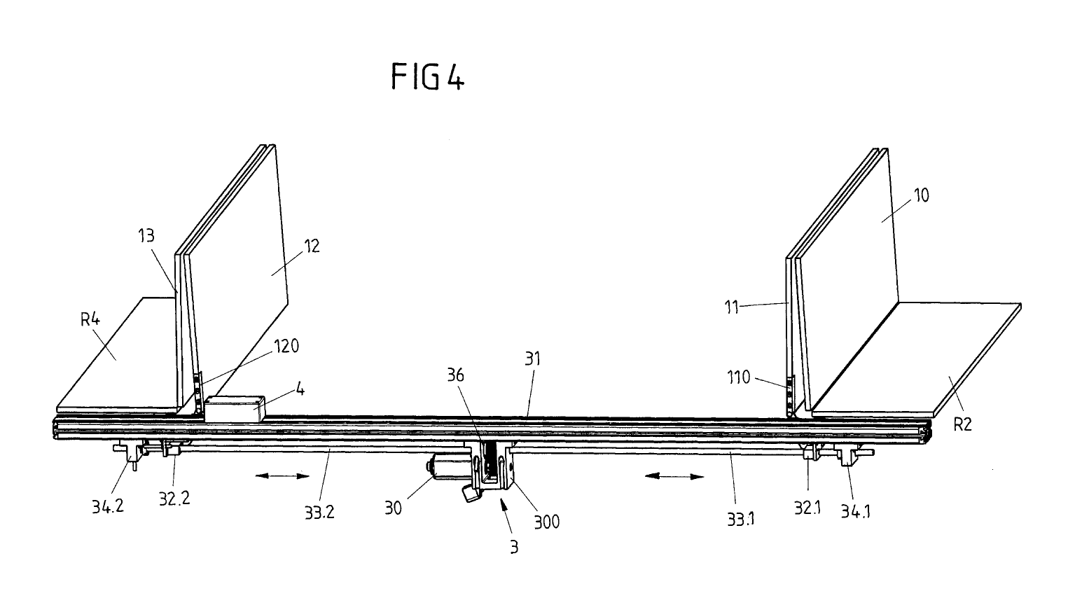

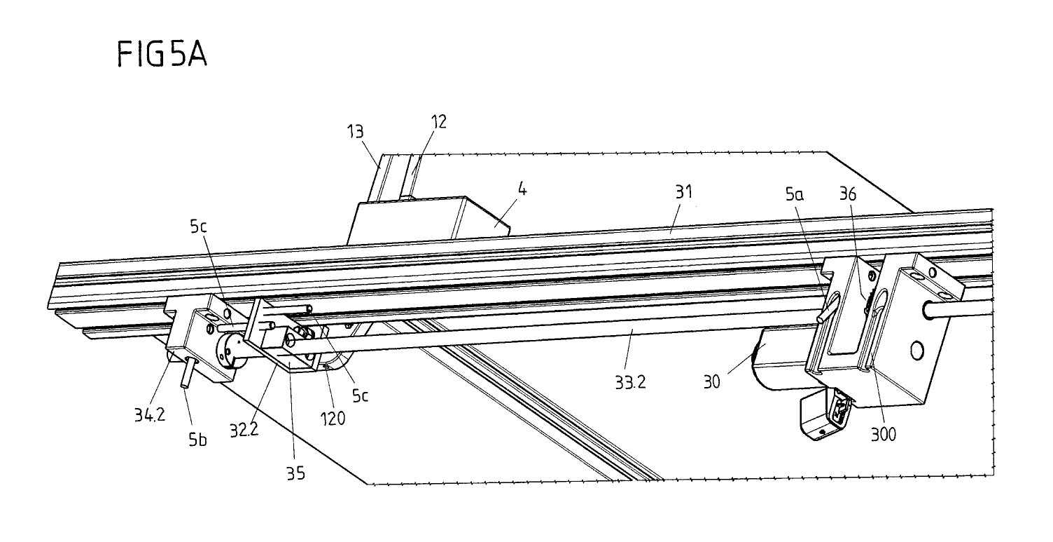

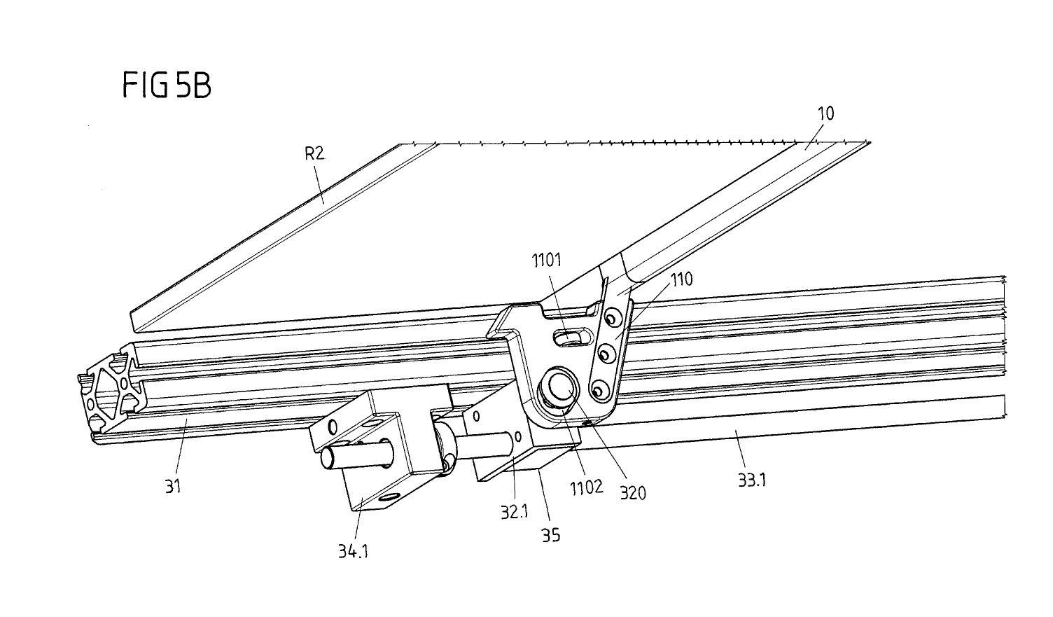

The drive unit 3 provided for the power-operated adjustment of the floor cover 1 in the present case among other things includes a drive motor 30 via which an adjusting force can be applied to the two respective inner covering plates 11 and 12 in order to open and close the floor cover 1. The drive motor 30 here is provided centrally at a front end, i.e. at an end facing a rear seat when the motor is accommodated in a rear-side loading space. Via a motor mount 300 the drive motor 30 is fixed to a guide rail 31 of the drive unit 3. The guide rail 31 in the present case forms a guide element of the drive unit 3 on which the inner covering plates 11 and 12 are longitudinally shiftably guided. To provide for a folding up of the covering plates 10 to 13 for opening the floor cover 1, the inner covering plates 11, 12 each are articulated to a traveling part in the form of a (driver) carriage 32.1 or 32.2 via a coupling element 110 or 120. This carriage 32.1 or 32.2 is translatorily shiftable along the guide rail 31. While the respective coupling element 110 or 112, as shown for example in FIG. 5B, is shiftably held on the guide rail 31, the respective carriage 32.1 or 32.2 is shiftably mounted on two threaded rods 33.1 and 33.2 of a spindle drive of the drive unit 3 which extend parallel to the guide rail 31. The threaded rods 33.1 and 33.2 thus form drive elements by means of which the carriages 32.1 and 32.2, in combination with a spindle nut 35 present per carriage, are moved along an axis—preferably synchronously to each other—that extends transversely to the rotational and hinge axes of the covering flaps 10 to 13. For opening and closing the floor cover 1, the carriages 32.1, 32.2 are driven via the drive motor 30 to perform a translatory adjusting movement in opposite directions of adjustment. The torque of the drive motor 30 is transmitted to the threaded rods 33.1 and 33.2 by means of a single-stage gearwheel transmission 36 of the drive unit 3. This gearwheel transmission 36 is arranged in the motor mount 300. FIG. 4 shows the mounting position of the gearwheel transmission 36 in the motor mount 300.

The threaded rods 33.1 and 33.2 arranged below the guide rail 31 are held on the motor mount 300 and on rod holders 34.1 and 34.2 spaced apart from each other. Approximately centrally between these rod holders 34.1 and 34.2 the drive motor 30 is placed via the motor mount 300. Both the rod holders 34.1 and 34.2 and the motor mount 300 here are mounted on the guide rail 31. The guide rail 31 thus also forms a cross-beam of the device V—preferably as part of the loading floor insert E—for fixing and supporting the components of the drive unit 3.

On one side of the guide rail 31, there can also be held a control device 4, as control unit of the device V, for controlling the adjusting movement of the covering plates 10 to 13. The electronic control system provided by means of the control device 4 can contain an overcurrent detection to safeguard a reliable operation.

At a rear end of the loading space (in the region of a front loading edge LK) two electric actuation keys 6 of the device V are provided in the present case. A desired opening or closing movement of the floor cover 1 thereby can manually be triggered by a user in the loading space itself. A triggered adjusting movement of the carriages 32.1, 32.2 is stopped automatically upon reaching one of the two possible end positions, which corresponds with a completely open or completely closed condition of the floor cover 1. For stopping automatically, the drive unit 3 in the present case includes a plurality of switches 5a, 5b and a contactor 5c, which upon contact of a contactor 5c with a switch 5a or 5h generate a signal for the defined switching off of the drive motor 30. In the design variant of FIGS. 2 to 5B limit switches 5a and 5b for a carriage 32.1 or 32.2 therefor are provided on the one hand on a rod holder 34.1 or 34.2 and on the other hand on the motor mount 300 (cf. FIG. 5A). The respectively associated contactors 5c, which get in contact with these limit switches 5a or 5b in the respective end position, are provided on the carriage 32.1 or 32.2.

In particular the drive motor 30 and the carriages 32.1 and 32.2 of the drive unit 3, which are shiftable along the threaded rods 33.1 and 33.2, in the present case are arranged below a loading floor plane that is defined by the closed floor cover 1 and the covering plates 10 to 13 then juxtaposed. Since furthermore the components of the drive unit 3 then also are arranged at a distance from a front loading floor edge LK, which faces a tailgate opening of the vehicle, the drive unit 3 can be accommodated in a space-saving and inconspicuous way in the region of the rear-side loading space and preferably below a rear seat.

As can be seen in particular with reference to FIG. 2, means for securing the covering plates 11 and 12 to each other in the closed position can be provided on the coupling elements 110 and 120 of the two inner covering plates 11 and 12, which each are fixed to a corner of a covering plate 11 or 12. For example, the two coupling elements 110 and 120 interlock with each other when the floor cover 1 is closed, so that an arrestment 16 is defined thereby. Via this arrestment 16 an inadvertent displacement of the covering plates 11 and 12 with properly closed floor cover 1 is prevented. Only when a longitudinal displacement of the covering plates 11 and 12 by application of opposite adjusting forces is effected via the carriages 32.1 and 32.2 this arrestment 16 is released, so that the floor cover 1 can be opened.

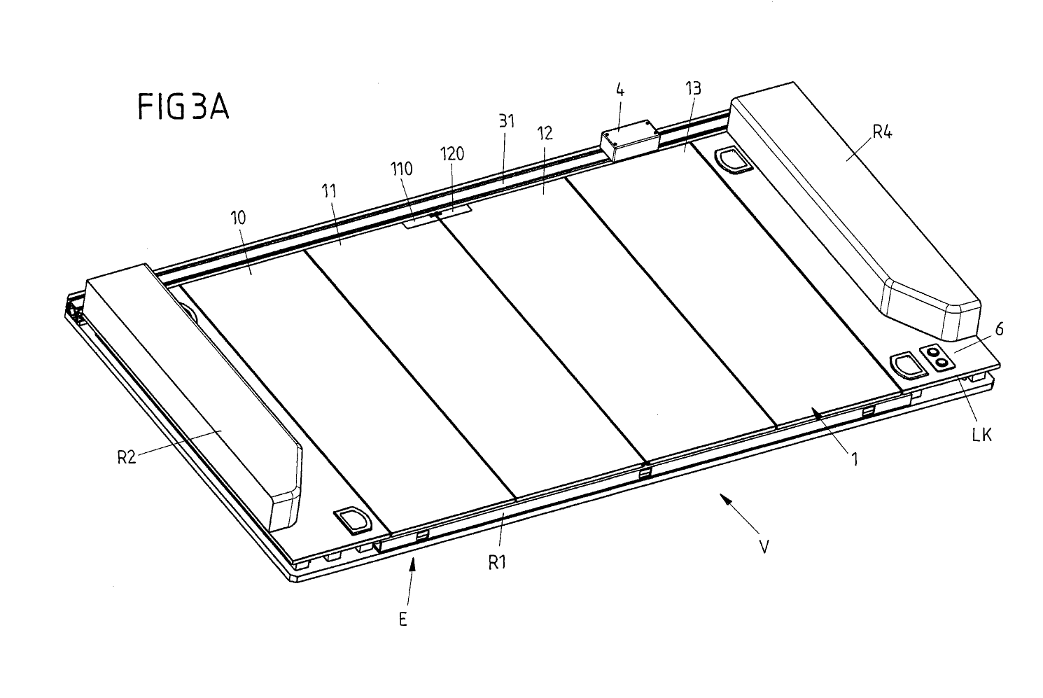

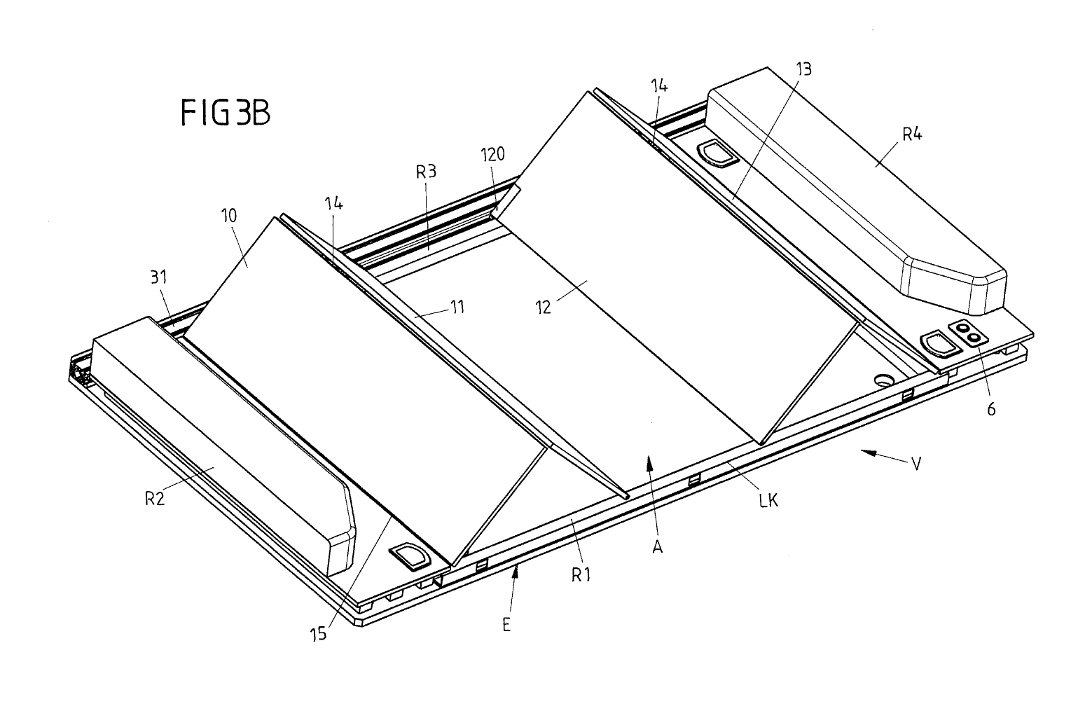

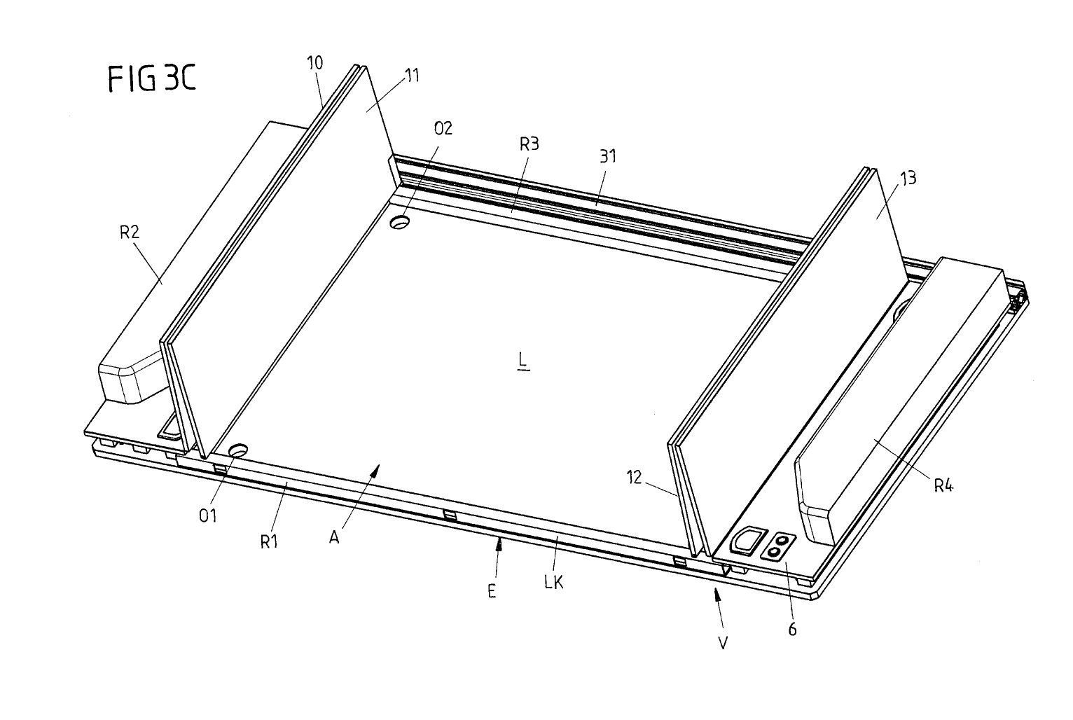

The sequence of the adjusting movement on opening of the floor cover, which is shown in FIGS. 3A to 3C, substantially is identical to the variant of FIGS. 1A to 1D explained above. When the floor cover 1 corresponding to FIGS. 3C and 4 is completely opened and the covering plates 10 to 13 hence are folded onto each other in pairs, the underlying receptacle A is completely accessible and the loading area L is exposed.

Although in the design variant shown here the loading area L also is designed with openings (of which the openings O1 and O2 are shown in FIG. 3C) such that a securing element in the form of the securing mat 2 placed in the receptacle A can be extended by means of the link chains 22a to 22d, this is not absolutely necessary. The receptacle A of trough-like design also can be utilized for accommodating other objects. The receptacle A thus forms a kind of storage box which can be closed completely by the floor cover 1 adjustable in a power-operated way and can be opened upon request of a user without a manual intervention. As shown, this storage box can have a base area that occupies at least ⅔ of the base area of the loading space. In principle, its base area can vary however depending on the size of the loading space and the case of application.

As can be seen with reference to the detail representation in FIG. 5B, a coupling element 110 (like also a mirror-symmetrical coupling element 120) in the present case includes two guide rollers 1101 and 1102. Via these guide rollers 1101 and 1102 the coupling element 110 (120) fixed to the respective covering plate 11 (or 12) on the one hand is shiftably mounted on the guide rail 31 and on the other hand connected to the associated carriage 32.1 (32.2).

Corresponding to FIG. 5B, an articulated connection is provided for the connection between the carriage 32.1 and the coupling element 110, via which the coupling element 110 can be entrained by the carriage 32.1 in order to adjust the same along the adjustment path specified by the guide rail 31 and a threaded rod 33.1. Via the articulated connection, the coupling element 110 also is pivotally held on the carriage 32.1 in order to permit a swivel movement of the coupling element 110 and hence of the covering plate 11 in the case of a longitudinal displacement of the carriage 32.1 along the threaded rod 33.1. In the present case, the articulated connection is realized via a drive pin 320, which protrudes from the carriage 32.1 transversely to the direction of extension of the threaded rod 33.1, and a bearing opening on the coupling element 110 for the guide roller 1102, into which this drive pin 320 engages. To avoid an abrupt impact on the coupling element 110 during the adjustment and in particular at the beginning of an adjusting movement and to prevent wedging between closed covering plates 10, 11 and 12, 13, there is no coaxial connection between the drive pin 320 and the coupling element 110, but a relative movement between the coupling element 110 and the associated carriage 32.1 deliberately is permitted via the bearing opening of the coupling element 110. Here, a combination of a short translational movement and a swivel movement of the coupling element 110 is permitted. In addition, the drive pin 320 preferably is provided with a damping material, for example coated with a damping material or connected to a separate damping element made of such a damping material.

The detail representation of FIG. 5B furthermore reveals a wedge-shaped tab on the coupling element 110, which in the open position of the floor cover 1 has a tapering end pointing in an opening direction along the threaded rod 33.1 (away from the motor mount 300). This tab has an oblique upper side facing the underside of the floor cover 1. When opening the floor cover 1, the retraction of the coupling element 110 below the stationary edge portion R2 thereby is facilitated.

### LIST OF REFERENCE NUMERALS

1 floor cover
10-13 covering plate (covering element)
110, 120 coupling element
1101, 1102 guide roller
14 hinge (rotary joint)
15 plate hinge (rotary plate joint)
16 arrestment
2 securing mat (securing element)
20 textile part
21 support frame
21a-21d corner piece
22a-22d link chain (adjusting element)
3 drive unit
30 drive motor
300 motor mount
31 guide rail
32.1, 32.2 carriage (traveling part)
320 drive pin
33.1, 33.2 threaded rod (drive element)
34.1, 34.2 rod holder
35 spindle nut
36 gearwheel transmission
4 control device
5a limit switch, inside
5b limit switch, outside
5c contactor
6 actuation key
A receptacle
E loading floor insert
L loading area
LK front loading floor edge
O1-O3 opening
R1-R4 edge portion
V device

1. A device for securing at least one object that is arranged on a loading area of a loading space of a vehicle, comprising
a securing element that is adjustable in a power-operated way between a position of non-use and a position of use and in the position of use can take a loading position and a securing position, wherein in the loading position at least one object can be arranged on the loading area and in the securing position the at least one object is held in a position on the loading area via the securing element, and
a floor cover that protectively covers the securing element in its position of non-use and in the position of non-use of the securing element defines a portion of a loading floor on which at least one object can be arranged.

2. The device according to claim 1, wherein at least one element of the floor cover is pivotally mounted and/or can be wound in order to adjust the floor cover.

3. The device according to claim 2, wherein in the properly mounted condition a pivotable element of the floor cover can be pivoted to the right or left or in the direction of the vehicle front with respect to a longitudinal vehicle axis in order to provide for an adjustment of the securing element from its position of non-use into its position of use.

4. The device according to claim 1, wherein the floor cover comprises at least two covering elements articulated to each other, which each cover the securing element in its position of non-use and define a portion of the loading floor.

5. The device according to claim 4, wherein the at least two covering elements articulated to each other can be folded onto each other in order to provide for an adjustment of the securing element from its position of non-use into its position of use.

6. The device according to claim 4, wherein at least two pairs of covering elements each articulated to each other are provided.

7. The device according to claim 2, wherein the floor cover comprises at least two covering elements articulated to each other, which each cover the securing element in its position of non-use and define a portion of the loading floor, and at least one first covering element is pivotally mounted on a component firmly installed in the loading space and a further, second covering element is pivotally mounted on the first covering element by being articulated to the same.

8. The device according to claim 7, wherein at least two pairs of covering elements each articulated to each other are provided and each pair of covering elements comprises a first covering element that is pivotally mounted on a component firmly installed in the loading space, and the two first covering elements are pivotable in opposite directions in order to provide for an adjustment of the securing element from its position of non-use into its position of use.

9. The device according to claim 4, wherein at least one covering element is shiftably guided on a component firmly installed in the loading space.

10. The device according to claim 1, wherein in its position of non-use the securing element is accommodated in a receptacle which in the position of non-use of the securing element is completely covered by the floor cover.

11. A device for a loading space of a vehicle, wherein the loading space includes a loading area on which at least one object can be arranged and which at least partly forms the floor of a receptacle within the loading space, and wherein a floor cover is provided, which in a closed condition covers the loading area and at least partly closes the receptacle, so that the floor cover defines a portion of a loading floor above the loading area, on which at least one object can be arranged, and wherein the floor cover is adjustable into an open condition in a power-operated way in order to partly or completely gain access to the loading area.

12. The device according to claim 11, wherein the floor cover is adjustable in a power-operated way between a closed position and an open position, wherein in the open position an adjustment of the securing element from its position of non-use into the position of use is made possible.

13. The device according to claim 11, wherein a drive unit for the power-operated adjustment of the floor cover comprises at least one flexible traction means in order to transmit a pulling force for opening and/or closing the floor cover.

14. The device according to claim 11, wherein a drive unit for the power-operated adjustment of the floor cover comprises at least one spindle drive in order to transmit an adjusting force for opening and/or closing the floor cover.

15. The device according to claim 11, wherein a drive unit for the power-operated adjustment of the floor cover comprises at least one shiftably mounted traveling part that can be driven for a movement along an adjustment path, which cooperates with at least one element of the floor cover in order to open and/or close the floor cover.

16. The device according to claim 11, wherein a drive unit for the power-operated adjustment of the floor cover comprises at least one spring element via which a restoring force for closing or opening the floor cover is applied.

17. The device according to claim 1, wherein the floor cover is adjustable in a power-operated way between a closed position and an open position, wherein in the open position an adjustment of the securing element from its position of non-use into the position of use is made possible.

18. The device according to claim 17, wherein a drive unit for the power-operated adjustment of the floor cover comprises at least one flexible traction means in order to transmit a pulling force for opening and/or closing the floor cover.

19. The device according to claim 17, wherein a drive unit for the power-operated adjustment of the floor cover comprises at least one spindle drive in order to transmit an adjusting force for opening and/or closing the floor cover.

20. The device according to claim 17, wherein a drive unit for the power-operated adjustment of the floor cover comprises at least one shiftably mounted traveling part that can be driven for a movement along an adjustment path, which cooperates with at least one element of the floor cover in order to open and/or close the floor cover.
